(19) United States
(12) Patent Application Publication
(10) Pub. No.: US 2016/0341313 A1
(43) Pub. Date: Nov. 24, 2016

(54) GASKET RESTRAINT SYSTEM

(71) Applicant: Caterpillar Inc., Peoria, IL (US)

(72) Inventors: Saravanan Jayapalan, Chennai (IN); Shamshad S. Ahmed, Forsyth, IL (US); Landon J. Hamby, Vail, AZ (US)

(73) Assignee: Caterpillar Inc., Peoria, IL (US)

(21) Appl. No.: 15/229,835

(22) Filed: Aug. 5, 2016

(51) Int. Cl. F16J 15/02

(52) U.S. Cl. CPC F16J 15/022

(57) ABSTRACT

A gasket restraint system having a first plate, and a second plate coupled to the first plate using a fastening member is provided. The gasket restraint system includes a retainer disposed between the first plate and the second plate. The retainer includes a first opening for receiving the fastening member therethrough. The gasket restraint system also includes a gasket disposed between the first plate and the second plate. The gasket includes a first opening for receiving the retainer therein. The retainer is adapted to restrain movement of the gasket and restrict compression of the gasket to a threshold, when the fastening member is tightened.

### TECHNICAL FIELD

The present disclosure relates to sealing of a pair of plates with gaskets, and more specifically to a gasket restraint system for sealing the pair of plates with the gaskets.

### BACKGROUND

Sealing members are used in numerous applications to provide fluid tight sealing between two metal components. In an example, a power access system having hydraulic elements is used for lifting a stairway of a machine. A sealing member, for example, a bulb seal, is typically disposed between atop plate and a base plate of a platform of the power access systems. Therefore, a complete assembly of the top plate and the platform is sealed at an interface of the top plate and the base plate. However, the sealing member may fall inside the platform due to vibrations or jerks caused during an operation of the machine. The sealing member may also fall inside the platform while accessing various components disposed within the platform. Slippage between the sealing member and the base plate may cause accumulation of dirt inside the platform, which may in turn cause wear and premature failure of the components of the power access system.

US Patent Publication Number 2010/0123292, hereinafter referred to as ‘the '292 publication’, describes a gasket. The gasket has an annular metallic frame, and a seal portion made of an elastic material extending angularly along an inner peripheral portion of the metallic frame and connected to the metallic frame. The metallic frame has a penetration hole through which a shaft portion of a bolt that fastens two surfaces of an appliance that faces each other penetrates. A seat surface-corresponding portion is formed around the penetration hole, which corresponds to a seat surface of the bolt. However, the gasket, as described in the '292 publication, may not properly seal the two surfaces. Specifically, the gasket is slidable between the two surfaces and manufacturing of such gasket is costly and complex.

### SUMMARY OF THE DISCLOSURE

In one aspect of the present disclosure, a gasket restraint system having a first plate, and a second plate coupled to the first plate using a fastening member is provided. The gasket restraint system includes a retainer disposed between the first plate and the second plate. The retainer includes a first opening for receiving the fastening member therethrough. The gasket restraint system also includes a gasket disposed between the first plate and the second plate. The gasket includes a second opening for receiving the retainer therein. The retainer is adapted to restrain movement of the gasket and to restrict compression of the gasket to a threshold, when the fastening member is tightened.

In another aspect of the present disclosure, a gasket restraint system is provided. The gasket restraint system includes a first plate having a first through hole. The first through hole is adapted to receive a fastening member. The gasket restraint system also includes a retainer disposed around the first through hole of the first plate and defines a first opening adapted to receive the fastening member. The gasket restraint system also includes a gasket disposed on the first plate. The gasket includes a second opening adapted to receive the retainer. The gasket restraint system also includes a second plate disposed on the gasket. The second plate includes a second through hole adapted to receive the fastening member. The gasket restraint system further includes a coupling member coupled to the first plate and adapted to engage with the fastening member. The retainer is adapted to restrain movement of the gasket and to restrict compression of the gasket to a threshold, when the fastening member is tightened.

Other features and aspects of this disclosure will be apparent from the following description and the accompanying drawings.

### BRIEF DESCRIPTION OF THE DRAWINGS

FIG. 1 is a perspective view of a power access system having a gasket restraint system;

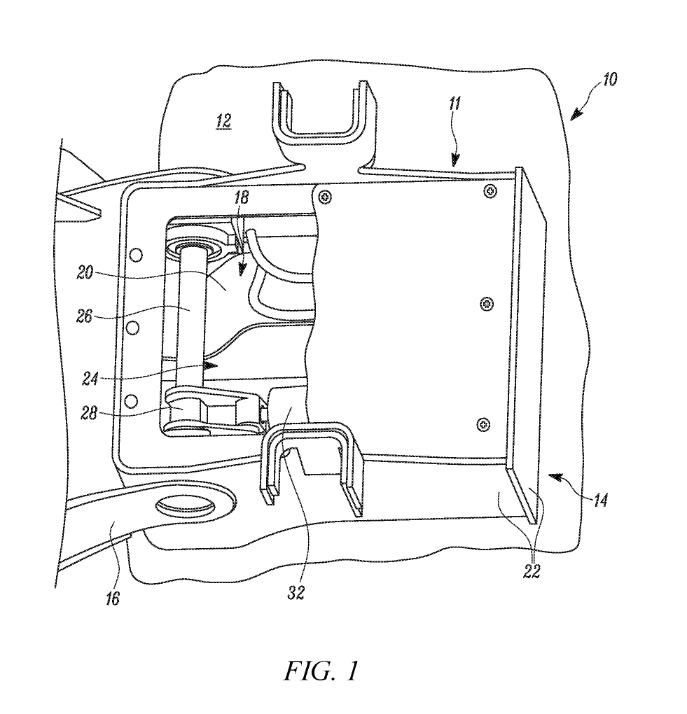

FIG. 2 is an exploded view of the gasket restraint system of FIG. 1 showing a gasket;

FIG. 3 is a sectional view of an assembly of the gasket restraint system having the gasket in an uncompressed state; and

FIG. 4 is a sectional view of an assembly of the gasket restraint system having the gasket in a compressed state.

### DETAILED DESCRIPTION

An exemplary power access system 10 having a gasket restraint system 11 is shown in FIG. I. The power access system 10 may be employed in a stationary or a mobile machine associated with industries, such as construction, mining, agriculture, and transportation. In an example, the power access system 10 is mounted on a frame 12 of a machine (not shown) and coupled to a stairway 16, which is used for enabling ingress and egress of an operator to the machine from ground. The power access system 10 includes a platform 14 coupled to the frame 12. The stairway 16 is pivotally coupled to the platform 14. A lifting mechanism 18 disposed within the platform 14 for lifting the stairway 16. The platform 14 includes a base plate 20 attached to the frame 12 of the machine. The platform 14 also includes multiple side plates 22 extending from the base plate 20. The multiple side plates 22 and the base plate 20 together define a chamber 24 for receiving the lifting mechanism 18 therein.

The lifting mechanism 18 may include a hydraulic drive having multiple drive components, such as a shaft 26, a connecting arm 28, a cylinder 32, a pump (not shown), and an accumulator (not shown). The multiple drive components are disposed in the chamber 24 of the platform 14. Various other components, such as fluid conduits and electric cables, may also be disposed within the chamber 24. The gasket restraint system 11 of the power access system 10 is mounted on the platform 14 to conceal the lifting mechanism 18 within the chamber 24.

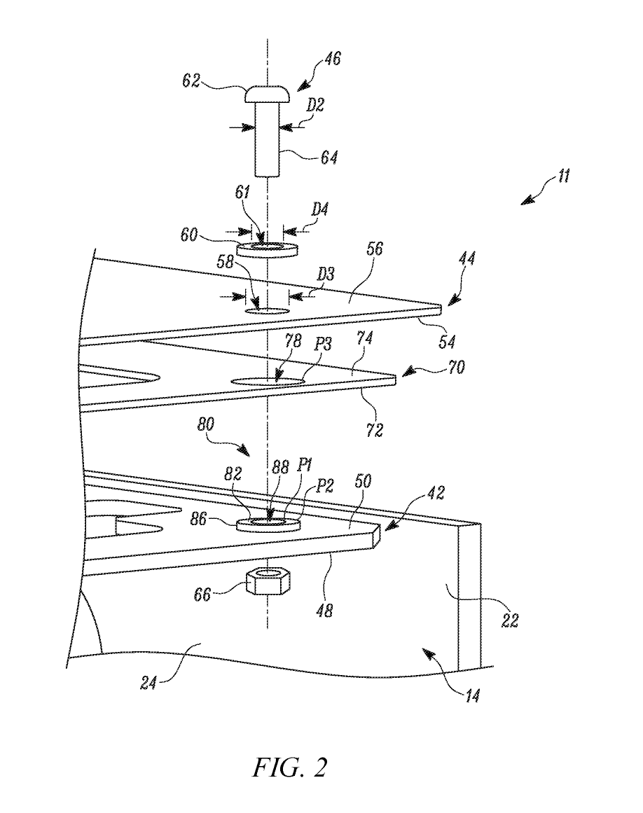

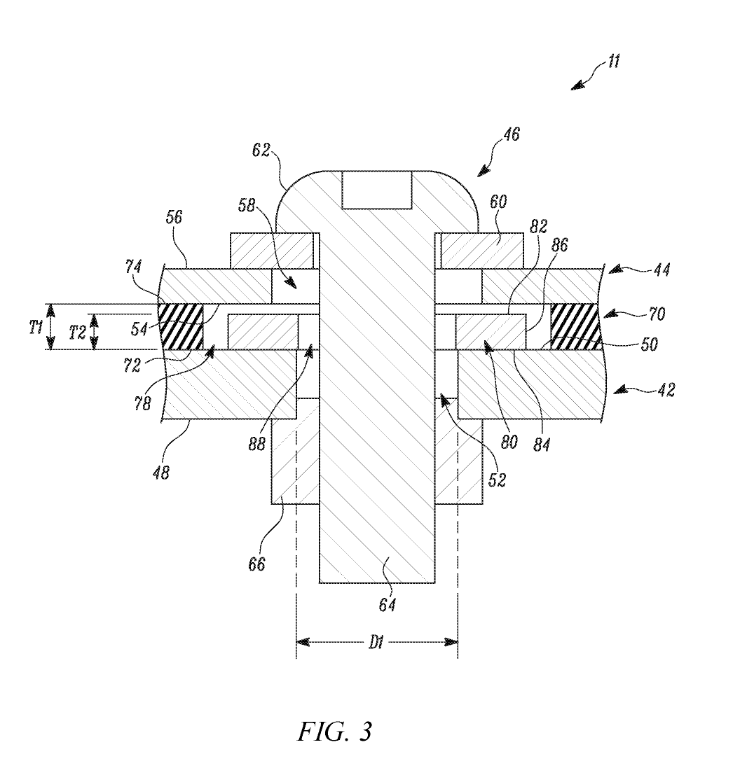

Referring to FIG. 2, the gasket restraint system 11 includes a first plate 42 mounted on the platform 14, and a second plate 44 coupled to the first plate 42 by using a fastening member 46. The first plate 42 includes a first surface 48 facing the chamber 24 of the platform 14 and a second surface 50 opposite to the first surface 48. The first plate 42 also includes a first through hole 52 extending between the first surface 48 and the second surface 50. The first through hole. 52 (shown in FIG. 3) has an inner diameter ‘D1’ greater than an outer diameter ‘D2’ of the fastening member 46 to receive the fastening member 46 therethrough. The second plate 44 includes a third surface 54, and a fourth surface 56 opposite to the third surface 54. The second plate 44 also includes a second through hole 58 extending between the third surface 54 and the fourth surface 56. The second through hole 58 has an inner diameter ‘D3’ greater than the outer diameter ‘D2’ of the fastening member 46 to receive the fastening member 46 therethrough. The second through hole 58 facilitates easy assembly of the second plate 44 on the first plate 42. Further, a spacer 60, such as a washer, is disposed on the fourth surface 56 of the second plate 44 for facilitating coupling of the second plate 44 with the first plate 42 using the fastening member 46. The outer diameter ‘D2’ of the fastening member 46 is smaller than an inner diameter ‘D4’ of an opening 61 of the spacer 60 such that the fastening member 46 passes through the spacer 60, during assembly of the gasket restraint system 40.

The fastening member 46 includes a head portion 62 and a shank portion 64 extending from the head portion 62. In the illustrated embodiment, the fastening member 46 is a bolt. In order to tighten the fastening member 46, the gasket restraint system 40 also includes a coupling member 66 that engages with the shank portion 64 of the fastening member 46 to couple the first plate 42 with the second plate 44. In the illustrated embodiment, the coupling member 66 is a nut. The coupling member 66 may be welded to the first surface 48 of the first plate 42. The coupling member 66 includes internal threads that engage with external threads of the shank portion 64 of the fastening member 46, when the fastening member 46 is tightened. In various examples, the coupling member 66 may be an integral component of the first pate 42 and may be provided with threads. Additionally or alternatively, the first plate 42 may also include threaded portion that engages with external threads of the shank portion 64 of the fastening member 46

Referring to FIGS. 2 and 3, the gasket restraint system 11 further includes a gasket 70 disposed on the second surface 50 of the first plate 42. Specifically, the gasket 70 is disposed between the second surface 50 of the first plate 42 and the third surface 54 of the second plate 44. The gasket 70 includes a fifth surface 72, and a sixth surface 74 opposite to the fifth surface 72. The fifth surface 72 is adapted to abut the second surface 50 of the first plate 42 and the sixth surface 74 is adapted to abut the third surface 54 of the second plate 44. The gasket 70 has a thickness ‘T1’ defined between the fifth surface 72 and the sixth surface 74.

The gasket 70 is made from an elastomeric material, for example chloroprene rubber. In order to affect fluid tight sealing between the first plate 42 and the second plate 44, the gasket 70 is clamped and compressed between the first plate 42 and the second plate 44 by tightening the fastening member 46. However, compression of the gasket 70 beyond an elastic limit of the gasket 70 may lead to lose of elastic property in the gasket 70. The gasket restraint system 11 includes a retainer 80 disposed between the first plate 42 and the second plate 44 to restrict compression of the gasket 70 to a threshold, when the fastening member 46 is tightened.

The retainer 80 also restrains a movement of the gasket 70 between the first plate 42 and the second plate 44. The retainer 80 is an annular member disposed on the second surface 50 of the first plate 42 and surrounds the first through hole 52. In one example, the retainer 80 may be welded to the second surface 50 of the first plate 42. In another example, the retainer 80 may be a integral portion of the first plate 42 and may extend around the first through hole 52. In yet another example, the retainer 80 may be welded to the third surface 54 of the second plate 44. The retainer 80 includes an upper surface 82, a lower surface 84 opposite to the upper surface 82, and a side surface 86 extending between the upper surface 82 and the lower surface 84. The retainer 80 also includes a first opening 88 extending between the upper surface 82 and the lower surface 84. The first opening 88 receives the fastening member 46 therethrough, during assembly of the gasket restraint system 40. In assembled condition of the gasket restraint system 11, the retainer 80 is received within a second opening 78 defined in the gasket 70 and disposed between the first plate 42 and the second plate 44. The second opening 78 extends between the fifth surface 72 and the sixth surface 74 of the gasket 70.

The retainer 80 has an inner perimeter ‘P1’ and an outer perimeter ‘P2’. The inner perimeter ‘P1’ of the retainer 80 is greater than a circumference of the shank portion 64 defined by the diameter ‘D2’. In one example, the outer perimeter ‘P2’ of the retainer 80 is less than a perimeter ‘P3’ of the second opening 78 of the gasket 70. In another example, the outer perimeter ‘P2’ of the retainer 80 is equal to the perimeter ‘P3’ of the second opening 78 of the gasket 70. Specifically, the inner perimeter ‘P1’ of the first opening 88 of the gasket 70 is greater than or equal to the outer perimeter ‘P2’ of the retainer 80. Further, the retainer 80 has a thickness ‘T2’ defined between the upper surface 82 and the lower surface 84. The thickness ‘T2’ of the retainer 80 is less than the thickness ‘T1’ of the gasket 70, when the gasket 70 is in uncompressed state. In an example, a ratio of the thickness ‘T2’ of the retainer 80 to the thickness ‘T1’ of the gasket 70 is 3:4.

### INDUSTRIAL APPLICABILITY

The present disclosure relates to the gasket restraint system 11. As described above, the gasket restraint system 40 includes the first plate 42, and the second plate 44 coupled to the first plate 42 by using the fastening member 46. The gasket restraint system 11 also includes the gasket 70 to affect sealing between the first plate 42 and the second plate 44. During assembly of the gasket restraint system 11, the gasket 70 is disposed on the first plate 42 such that the retainer 80 is received within the second opening 78 of the gasket 70.

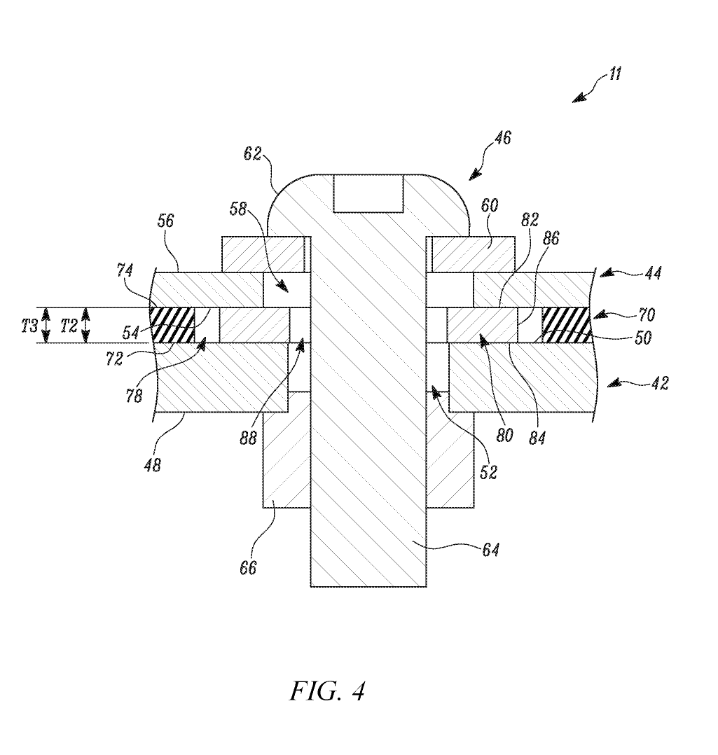

Referring to FIG. 4, in order to produce the fluid tight sealing effect between the first plate 42 and the second plate 44, the gasket 70 is clamped and compressed between the first plate 42 and the second plate 44 by tightening the fastening member 46. The retainer 80 restricts compression of the gasket 70 to the threshold, when the fastening member 46 is tightened. The threshold may be defined as a compression of the gasket 70 by 25% of the thickness ‘T1’ thereof. In the illustrated embodiment, the threshold is defined by a difference between the thickness ‘T2’ of the retainer 80 and thickness ‘T1’ of the gasket 70. Specifically, when the fastening member 46 is tightened, the second plate 44 moves towards the first plate 42 to bring the gasket 70 to a compressed state. In the compressed state of the gasket 70, the gasket 70 has a thickness ‘T3’ that is equal to the thickness ‘T2’ of the retainer 80. Compression of the gasket 70 to the thickness ‘T3’ between the first plate 42 and the second plate 44 causes the fluid tight sealing between the first plate 42 and the second plate 44, and thereby prevents foreign materials, such as dirt and fluids, from entering the chamber 24 of the platform 14. Further, compression of the gasket 70 beyond the threshold is prevented by the retainer 80 by restricting further movement of the second plate 44 to the first plate 42.

Hence, the retainer 80 of the present disclosure facilitates positioning of the gasket 70 on the first plate 42. Specifically, the retainer 80 restrains movement of the gasket 70 between the first plate 42 and the second plate 44. In an example, the perimeter ‘P3’ of the second opening 78 of the gasket 70 is greater than the outer perimeter ‘P2’ of the retainer 80 such that a clearance may be defined between the gasket 70 and the retainer 80. The clearance may also be defined to accommodate a weld seam provided between the side surface 86 of the retainer 80 and the second surface 50 of the first plate 42. Upon compression of the gasket 70, the gasket 70 may bulge towards the retainer 80 and contact the retainer 80 to provide a tight fit between the gasket 70 and the retainer 80. Thus, the gasket 70 is kept in a desired position between the first plate 42 and the second plate 44 without any movement over a period of time. Moreover, slippage of the gasket 70 between the first plate 42 and the second plate 44 is completely eliminated.

What is claimed is:

1. A gasket restraint system having a first plate, and a second plate coupled to the first plate using a fastening member, the gasket restraint system comprising:
a retainer disposed between the first plate and the second plate, the retainer including a first opening for receiving the fastening member therethrough; and
a gasket disposed between the first plate and the second plate, the gasket including a second opening for receiving the retainer therein,
wherein the retainer is adapted to restrain movement of the gasket and to restrict compression of the gasket to a threshold, when the fastening member is tightened.

2. The gasket restraint system of claim 1, wherein an inner perimeter of the second opening of the gasket is greater than or equal to an outer perimeter of the retainer.

3. The gasket restraint system of claim 1 comprising a spacer disposed on the second plate and a coupling member welded to the first plate, wherein the fastening member passes through the spacer and engages with the coupling member.

4. A gasket restraint system comprising:
a first plate including a first through hole adapted to receive a fastening member;
a retainer disposed around the first through hole of the first plate and defining a first opening adapted to receive the fastening member;
a gasket disposed on the first plate, and including a second opening adapted to receive the retainer;
a second plate disposed on the gasket, and including a second through hole adapted to receive the fastening member; and
a coupling member coupled to the first plate adapted to engage with the fastening member,
wherein the retainer is adapted to restrain movement of the gasket and to restrict compression of the gasket to a threshold, when the fastening member is tightened.
